(19) United States
(12) Patent Application Publication
(10) Pub. No.: US 2011/0262716 A1
(43) Pub. Date: Oct. 27, 2011

(54) Magenta Dyes and Inks for Use in Ink-Jet Printing

(75) Inventors: Gavin Wright, Manchester (GB); Toshiki Fujiwara, Kanagawa (JP)

(73) Assignees: FUJIFILM CORPORATION; FUJIFILM IMAGING COLORAMTS. LIMITED

(21) Appl. No.: 13/133,331

(22) PCT Filed: Nov. 26, 2009
(86) PCT No.: PCT/GB2009/051602

§ 371 Date: Jun. 7, 2011

(30) Foreign Application Priority Data
Dec. 20, 2008 (GB) 0823268.8

(51) Int. Cl. B32B 3/10; B41J 2/175; B41J 2/01; C09B 29/42; C09D 11/02

(52) U.S. Cl. 428/195.1; 534/766; 106/31.48; 347/100; 347/86

(57) ABSTRACT

A compound of Formula (1) and salts thereof:

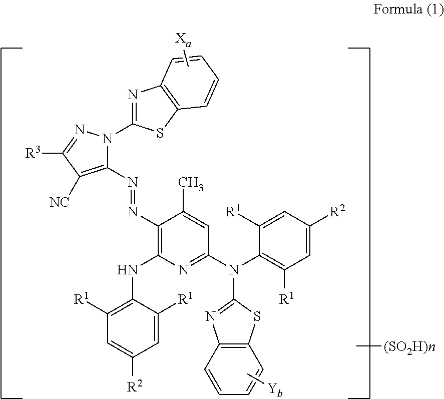

wherein:
R¹ and R² are independently H or optionally substituted C₁₋₄alkyl;
R³ is optionally substituted aryl or optionally substituted heteroaryl;
X and Y are independently an acetyl group, an acetate ester group, a carbonamide group, a sulfoxide group, a sulfone group, a phosphonate group, a nitro group, a nitrile group, an isonitrile group, a quaternary amine, a carbonyl group (other than a carboxylic acid), a polyhaloalkyl group or a halogen atom;
a+b=0 to 4; and
n=1 to 6. Also ink-jet compositions, processes and cartridges and printed material.

This invention relates to dyes, to compositions and inks for ink-jet printers, to printing processes, to printed substrates and to ink-jet printer cartridges.

Ink-jet printing is a non-impact printing technique in which droplets of ink are ejected through a fine nozzle onto a substrate without bringing the nozzle into contact with the substrate. The set of inks used in this technique typically comprise yellow, magenta, cyan and black inks.

With the advent of high-resolution digital cameras and ink-jet printers it is becoming increasingly common for consumers to print off photographs using an ink-jet printer.

While ink-jet printers have many advantages over other forms of printing and image development there are still technical challenges to be addressed. For example, there are the contradictory requirements of providing ink colorants that are soluble in the ink medium and yet display excellent wet-fastness (i.e. prints do not run or smudge when printed). The inks also need to dry quickly to avoid sheets sticking together after they have been printed, but they should not form a crust over the tiny nozzles in the printer head. Storage stability is also important to avoid particle formation that could block the tiny nozzles used in the printer especially since consumers can keep an ink-jet ink cartridge for several months. Furthermore, and especially important with photographic quality reproductions, the resultant images should not bronze or fade rapidly on exposure to light or common oxidising gases such as ozone. It is also important that the shade and chroma of the colorant are exactly right so that any image may be optimally reproduced.

Thus developing new colorants for ink-jet printing presents a unique challenge in balancing all these conflicting and demanding properties.

The present invention provides a compound of Formula (1) and salts thereof:

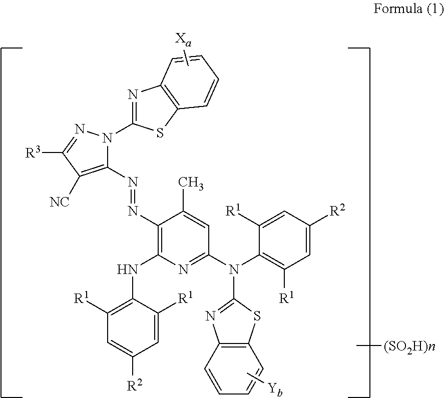

wherein:
R¹ and R² are independently H or optionally substituted C₁₋₄alkyl;
R³ is optionally substituted aryl or optionally substituted heteroaryl;
X and Y are independently an acetyl group, an acetate ester group, a carbonamide group, a sulfoxide group, a sulfone group, a phosphonate group, a nitro group, a nitrile group, an isonitrile group, a quaternary amine, a carbonyl group (other than a carboxylic acid), a polyhaloalkyl group or a halogen atom;
a+b=0 to 4; and
n=1 to 6.

Preferably R¹ and R² are independently H or unsubstituted C₁₋₄alkyl (especially methyl and ethyl).

Preferably R¹ is methyl or ethyl.

Preferably R² is methyl.

Preferably R³ is optionally substituted phenyl or optionally substituted naphthyl.

Preferably X and Y are independently selected from the group consisting of —Cl, —CN, —NO₂, —CF₃, —SO₂R⁴ wherein R⁴ is optionally substituted alkyl, optionally substituted aryl or optionally substituted heterocyclyl, more preferably R⁴ is optionally substituted C₁₋₄ alkyl, especially unsubstituted C₁₋₄ alkyl and more especially methyl.

More preferably X and Y are independently —Cl and —SO₂R⁴; and particularly —Cl.

Preferably X and Y are the same.

Preferably a is 1.

Preferably b is 1.

Preferably (a+b) is 1 to 4, more preferably (a+b) is 2.

Preferably n is 3 to 6, more preferably 4 to 6 and especially 5.

In one preferred embodiment R¹ is methyl or ethyl, R² is methyl, R³ is optionally substituted phenyl, (a+b) is 0 and n is 4 to 6.

Optional substituents which may be present on R¹, R² or R⁴, when it is optionally substituted alkyl, are preferably independently selected from: optionally substituted aryl (preferably optionally substituted phenyl), optionally substituted aryloxy (preferably optionally substituted phenoxy), optionally substituted heterocyclyl (including optionally substituted heteroaryl), polyalkylene oxide (preferably polyethylene oxide or polypropylene oxide), CO₂H, SO₃H, PO₃H₂, nitro, cyano, halo, ureido, —SO₂F, hydroxy, ester, sulphate, —NR^{a}R^{b}, —COR^{a}, —CONR^{a}R^{b}, —NHCOR^{a}, carboxyester, —SO₂R^{a}, —SO₂NR^{a}R^{b}, —S—R^{a}, —O—R^{a}, —NH—R^{a}, wherein R^{a}, R^{b} and R^{c} are each independently H, optionally substituted aryl (especially optionally substituted phenyl), optionally substituted alkyl (especially optionally substituted C₁₋₄-alkyl) or optionally substituted heterocyclyl. Optional substituents for any of the above substituents may be selected from the same list of substituents.

Optional substituents which may be present on R³ or R⁴, when it is optionally substituted aryl or optionally substituted heterocyclyl, are preferably independently selected from: optionally substituted alkyl (preferably optionally substituted C₁₋₄-alkyl); optionally substituted alkenyl (preferably optionally substituted C₁₋₄-alkenyl), optionally substituted alkynyl (preferably optionally substituted C₁₋₄-alkynyl), optionally substituted alkoxy (preferably optionally substituted C₁₋₄-alkoxy), optionally substituted aryl (preferably optionally substituted phenyl), optionally substituted aryloxy (preferably optionally substituted phenoxy), optionally substituted heterocyclyl (including optionally substituted heteroaryl), polyalkylene oxide (preferably polyethylene oxide or polypropylene oxide), CO₂H, SO₃H, PO₃H₂, nitro, cyano, halo, ureido, —SO₂F, hydroxy, ester, sulphate, —NR^{a}R^{b}, —COR^{a}, —CONR^{a}R^{b}, —NHCOR^{a}, carboxyester, —SO₂R^{a}, —SO₂NR^{a}R^{b}, —S—R^{a}, —O—R^{a}, —NH—R^{a}, wherein R^{a}, R^{b} and R^{c} are each independently H, optionally substituted aryl (especially optionally substituted phenyl), optionally substituted alkyl (especially optionally substituted C₁₋₄-alkyl) or optionally substituted heterocyclyl. Optional substituents for any of the above substituents may be selected from the same list of substituents.

The compounds of Formula (1) are also preferably free from fibre reactive groups. The term fibre reactive group is well known in the art and is described for example in EP 0356014 A1. Fibre reactive groups are capable, under suitable conditions, of reacting with the hydroxyl groups present in cellulosic fibres or with the amino groups present in natural fibres to form a covalent linkage between the fibre and the dye. As examples of fibre reactive groups excluded from the compounds of Formula (1) there may be mentioned aliphatic sulfonyl groups which contain a sulfate ester group in beta-position to the sulfur atom, e.g. beta-sulfato-ethylsulfonyl groups, alpha, beta-unsaturated acyl radicals of aliphatic carboxylic acids, for example acrylic acid, alpha-chloro-acrylic acid, alpha-bromoacrylic acid, propiolic acid, maleic acid and mono- and dichloro maleic; also the acyl radicals of acids which contain a substituent which reacts with cellulose in the presence of an alkali, e.g. the radical of a halogenated aliphatic acid such as chloroacetic acid, beta-chloro and beta-bromopropionic acids and alpha, beta-dichloro- and dibromopropionic acids or radicals of vinylsulfonyl- or beta-chloroethylsulfonyl- or beta-sulfatoethyl-sulfonyl-endo-methylene cyclohexane carboxylic acids. Other examples of cellulose reactive groups are tetrafluorocyclobutyl carbonyl, trifluorocyclobutenyl carbonyl, tetrafluorocyclobutylethenyl carbonyl, trifluorocyclobutenylethenyl carbonyl; activated halogenated 1,3-dicyanobenzene radicals; and heterocyclic radicals which contain 1, 2 or 3 nitrogen atoms in the heterocyclic ring and at least one cellulose reactive substituent on a carbon atom of the ring, for example a triazinyl halide.

Acid and basic groups on the compounds of Formula (1), particularly acid groups, are preferably in the form of a salt. Thus, the Formulae shown herein include the compounds in free acid and in salt form.

Preferred salts are alkali metal salts, especially lithium, sodium and potassium, ammonium and substituted ammonium salts (including quaternary amines such as ((CH₃)₄N⁺) and mixtures thereof. Especially preferred are salts with sodium, lithium, ammonia and volatile amines, more especially sodium salts. The compounds of Formula (1) may be converted into a salt using known techniques.

The compounds of Formula (1) may exist in tautomeric forms other than those shown in this specification. These tautomers are included within the scope of the present invention. However, tautomers may not bear a substituent on the hydroxy/enol oxygen.

Preferred compounds of Formula (1) may be prepared using analogous processes to those described in U.S. Pat. No. 7,108,743 which is incorporated herein by reference.

The skilled person will appreciate that the compounds of the present invention may be prepared by different processes. In one preferred process components, of the compounds of Formula (1), carrying sulfonic acid substituents are coupled to give discrete molecules. In another preferred process an intermediate is assembled which corresponds to a compound of Formula (1) but lacks any sulfonic acid groups. This intermediate is then sulfonated (preferably by oleum). The skilled person will appreciate that in this second preferred process the product will be a polydisperse mixture comprising multiple species sulfonated to varying degrees in different positions.

Thus, if a compound of the present invention is a discrete species prepared by the first preferred process then the sulfonic acid groups will shown in the structure in their known positions. If the position of the sulfonic acid substituents is not specified then the compound of the present invention was prepared by the second preferred process and in this case the number of sulfonic acid residues will be an average since the compound(s) formed will contain multiple species with differing levels of sulfonation

The compounds of Formula (1) are valuable colorants for use in the preparation of ink-jet printing inks, especially magenta inks. They benefit from a good balance of solubility, storage stability and fastness to ozone and light. In particular they display excellent ozone fastness.

According to a second aspect of the present invention there is provided a composition comprising a compound of Formula (1) and/or a salt thereof, as described in the first aspect of the invention, and a liquid medium.

Preferred compositions according to the second aspect of the invention comprise:
(a) from 0.01 to 30 parts of a compound of Formula (1) and salts thereof according to the first aspect of the invention; and
(b) from 70 to 99.99 parts of a liquid medium;
   wherein all parts are by weight.

Preferably the number of parts of (a)+(b)=100.

The number of parts of component (a) is preferably from 0.1 to 20, more preferably from 0.5 to 15, and especially from 1 to 5 parts. The number of parts of component (b) is preferably from 80 to 99.9, more preferably from 85 to 99.5 and especially from 95 to 99 parts.

Preferably component (a) is completely dissolved in component (b). Preferably component (a) has a solubility in component (b) at 20° C. of at least 10%. This allows the preparation of liquid dye concentrates that may be used to prepare more dilute inks and reduces the chance of the dye precipitating if evaporation of the liquid medium occurs during storage.

The inks may be incorporated in an ink-jet printer as a high concentration magenta ink, a low concentration magenta ink or both a high concentration and a low concentration ink. In the latter case this can lead to improvements in the resolution and quality of printed images. Thus the present invention also provides a composition (preferably an ink) where component (a) is present in an amount of 2.5 to 7 parts, more preferably 2.5 to 5 parts (a high concentration ink) or component (a) is present in an amount of 0.5 to 2.4 parts, more preferably 0.5 to 1.5 parts (a low concentration ink).

Preferred liquid media include water, a mixture of water and organic solvent and organic solvent free from water. Preferably the liquid medium comprises a mixture of water and organic solvent or organic solvent free from water.

When the liquid medium (b) comprises a mixture of water and organic solvent, the weight ratio of water to organic solvent is preferably from 99:1 to 1:99, more preferably from 99:1 to 50:50 and especially from 95:5 to 80:20.

It is preferred that the organic solvent present in the mixture of water and organic solvent is a water-miscible organic solvent or a mixture of such solvents. Preferred water-miscible organic solvents include C₁₋₆-alkanols, preferably methanol, ethanol, n-propanol, isopropanol, n-butanol, sec-butanol, tert-butanol, n-pentanol, cyclopentanol and cyclohexanol; linear amides, preferably dimethylformamide or dimethylacetamide; ketones and ketone-alcohols, preferably acetone, methyl ether ketone, cyclohexanone and diacetone alcohol; water-miscible ethers, preferably tetrahydrofuran and dioxane; diols, preferably diols having from 2 to 12 carbon atoms, for example ethylene glycol, propylene glycol, butylene glycol, pentylene glycol, hexylene glycol and thiodiglycol and oligo- and poly-alkyleneglycols, preferably diethylene glycol, triethylene glycol, polyethylene glycol and polypropylene glycol; triols, preferably glycerol and 1,2,6-hexanetriol; mono-C₁₋₄-alkyl ethers of diols, preferably mono-C₁₋₄-alkyl ethers of diols having 2 to 12 carbon atoms, especially 2-methoxyethanol, 2-(2-methoxyethoxy)ethanol, 2-(2-ethoxyethoxy)-ethanol, 2-[2-(2-methoxyethoxy)ethoxy]ethanol, 2-[2-(2-ethoxyethoxy)-ethoxy]-ethanol and ethyleneglycol monoallylether; cyclic amides, preferably 2-pyrrolidone, N-methyl-2-pyrrolidone, N-ethyl-2-pyrrolidone, caprolactam and 1,3-dimethylimidazolidone; cyclic esters, preferably caprolactone; sulfoxides, preferably dimethyl sulfoxide; and sulfones, preferably sulfolane. Preferably the liquid medium comprises water and 2 or more, especially from 2 to 8, water-miscible organic solvents.

Especially preferred water-miscible organic solvents are cyclic amides, especially 2-pyrrolidone, N-methyl-pyrrolidone and N-ethyl-pyrrolidone; diols, especially 1,5-pentane diol, ethyleneglycol, thiodiglycol, diethyleneglycol and triethyleneglycol; and mono-C₁₋₄-alkyl and C₁₋₄-alkyl ethers of diols, more preferably mono-C₁₋₄-alkyl ethers of diols having 2 to 12 carbon atoms, especially 2-methoxy-2-ethoxy-2-ethoxyethanol.

When the liquid medium comprises organic solvent free from water, (i.e. less than 1% water by weight) the solvent preferably has a boiling point of from 30 to 200° C., more preferably of from 40 to 150° C., especially from 50 to 125° C. The organic solvent may be water-immiscible, water-miscible or a mixture of such solvents. Preferred water-miscible organic solvents are any of the hereinbefore-described water-miscible organic solvents and mixtures thereof. Preferred water-immiscible solvents include, for example, aliphatic hydrocarbons; esters, preferably ethyl acetate; chlorinated hydrocarbons, preferably CH₂Cl₂; and ethers, preferably diethyl ether; and mixtures thereof.

When the liquid medium comprises a water-immiscible organic solvent, preferably a polar solvent is included because this enhances solubility of the dyes in the liquid medium. Examples of polar solvents include C₁₋₄-alcohols.

In view of the foregoing preferences it is especially preferred that where the liquid medium is organic solvent free from water it comprises a ketone (especially methyl ethyl ketone) and/or an alcohol (especially a C₁₋₄-alkanol, more especially ethanol or propanol).

The organic solvent free from water may be a single organic solvent or a mixture of two or more organic solvents. It is preferred that when the liquid medium is organic solvent free from water it is a mixture of 2 to 5 different organic solvents. This allows a liquid medium to be selected that gives good control over the drying characteristics and storage stability of the ink.

Liquid media comprising organic solvent free from water are particularly useful where fast drying times are required and particularly when printing onto hydrophobic and non-absorbent substrates, for example plastics, metal and glass.

The liquid media may of course contain additional components conventionally used in ink-jet printing inks, for example viscosity and surface tension modifiers, corrosion inhibitors, biocides, kogation reducing additives and surfactants which may be ionic or non-ionic.

Although not usually necessary, further colorants may be added to the ink to modify the shade and performance properties. Examples of such colorants include C.I. Direct Yellow 86, 132, 142 and 173; C.I. Direct Blue 307; C.I. Food Black 2; C.I. Direct Black 168 and 195; and C.I. Acid Yellow 23.

It is preferred that the composition according to the invention is ink suitable for use in an ink-jet printer. Ink suitable for use in an ink-jet printer is ink which is able to repeatedly fire through an ink-jet printing head without causing blockage of the fine nozzles. To do this the ink must be particle free, stable (i.e. not precipitate on storage), free from corrosive elements (e.g. chloride) and have a viscosity which allows for good droplet formation at the print head.

Ink suitable for use in an ink-jet printer preferably has a viscosity of less than 20 cP, more preferably less than 10 cP, especially less than 5 cP, at 25° C.

Ink suitable for use in an ink-jet printer preferably contains less than 500 ppm, more preferably less than 250 ppm, especially less than 100 ppm, more especially less than 10 ppm in total of divalent and trivalent metal ions (other than any divalent and trivalent metal ions bound to a colorant of Formula (1) or any other colourant or additive incorporated in the ink).

Preferably ink suitable for use in an ink-jet printer has been filtered through a filter having a mean pore size below 10 μm, more preferably below 3 μm, especially below 2 μm, more especially below 1 μm. This filtration removes particulate matter that could otherwise block the fine nozzles found in many ink-jet printers.

Preferably ink suitable for use in an ink-jet printer contains less than 500 ppm, more preferably less than 250 ppm, especially less than 100 ppm, more especially less than 10 ppm in total of halide ions.

A third aspect of the invention provides a process for forming an image on a substrate comprising applying a composition, preferably ink suitable for use in an ink-jet printer, according to the second aspect of the invention, thereto by means of an ink-jet printer.

The ink-jet printer preferably applies the ink to the substrate in the form of droplets that are ejected through a small orifice onto the substrate. Preferred ink-jet printers are piezoelectric ink-jet printers and thermal ink-jet printers. In thermal ink-jet printers, programmed pulses of heat are applied to the ink in a reservoir by means of a resistor adjacent to the orifice, thereby causing the ink to be ejected from the orifice in the form of small droplets directed towards the substrate during relative movement between the substrate and the orifice. In piezoelectric ink-jet printers the oscillation of a small crystal causes ejection of the ink from the orifice.

The substrate is preferably paper, plastic, a textile, metal or glass, more preferably paper, an overhead projector slide or a textile material, especially paper.

Preferred papers are plain or treated papers which may have an acid, alkaline or neutral character. Photographic quality papers are especially preferred. Photographic quality paper are which give a similar finish to that typically seen with silver halide photo printing.

A fourth aspect of the present invention provides a material preferably paper, plastic, a textile, metal or glass, more preferably paper, an overhead projector slide or a textile material, especially paper more especially plain, coated or treated papers printed with a compound of Formula (1) as described in the first aspect of the invention, a composition according to the second aspect of the invention or by means of a process according to the third aspect of the invention.

It is especially preferred that the printed material of the fourth aspect of the invention is a print on a photographic quality paper printed using a process according to the third aspect of the invention.

A fifth aspect of the present invention provides an ink-jet printer cartridge comprising a chamber and a composition, preferably ink suitable for use in an ink-jet printer, wherein the composition is in the chamber and the composition is as defined and preferred in the second aspect of the present invention. The cartridge may contain a high concentration ink and a low concentration ink, as described in the second aspect of the invention, in different chambers.

The invention is further illustrated by the following Examples in which all parts and percentages are by weight unless otherwise stated.

### EXAMPLE 1

### Preparation of

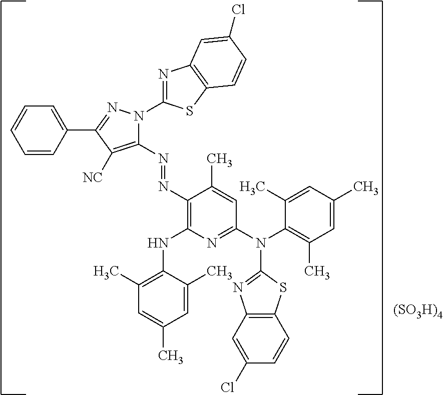

### Stage (a)

### Preparation of Intermediate (1a)

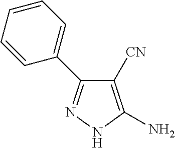

Benzoyl chloride (70 g, 0.50 mol) was added drop-wise to a mixture of malononitrile (33 g, 0.50 mol) and sodium hydroxide (40 g, 1.0 mol) in acetonitrile (200 ml) at 0-10° C. On completion of the addition the reaction mixture was stirred at 20° C. for 24 hours and then evaporated under reduced pressure. The resulting residue was added to a mixture of concentrated hydrochloric acid (125 ml) and ice (250 g), the precipitated product was filtered off and dried at 60° C. to give 90 g of a white powder. Sodium hydrogen carbonate (87 g, 0.50 mol) was added to a solution of the above solid in a mixture of tetrahydrofuran (200 ml) and water (10 ml), to this stirred suspension was slowly added dimethyl sulphate (131 g, 1.0 mol). The reaction mixture was stirred at reflux for 5 hours and then allowed to cool to room temperature. The reaction mixture was added to water (300 ml) and extracted with diethyl ether (3×150 ml), the combined extracts were dried over magnesium sulphate and evaporated under reduced pressure. The resultant oil was stirred in water (2000 ml) for 1 hour, the waxy solid thus obtained was collected by filtration and recrystallised from propan-2-ol to give 50 g of a cream solid. Hydrazine monohydrate (25 ml, 0.50 mol) was added drop-wise to a solution of the above solid in ethanol (250 ml) at 30-40° C. The reaction mixture was stirred for 2 hours at reflux, allowed to cool and added to water (4000 ml). The resultant precipitate slowly solidified and was collected by filtration. The crude product was purified by re-crystallisation from ethanol to give 46 g of a pale pink solid.

### Stage (b)

### Preparation of Intermediate (1b)

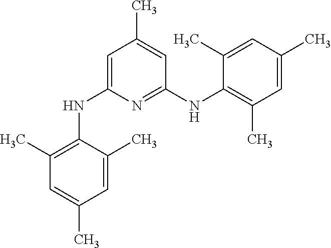

Intermediate (1b) was prepared according to the method described in WO 2002083795.

### Stage (c)

### Preparation of Intermediate (1c)

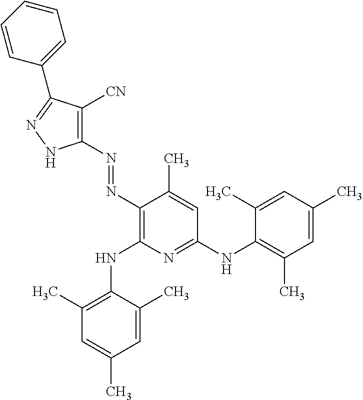

A suspension of the intermediate (1a) (45.8 g, 0.25 mol) in a mixture of acetic acid (700 ml), acetonitrile (700 ml) and water (150 ml) was warmed to 50° C. to obtain a solution. Intermediate (1b) (139 g, 0.28 mol) was added to the reaction mixture which was subsequently cooled to 25° C. before the addition of concentrated hydrochloric acid (160 ml). A solution of sodium nitrite (18 g, 0.26 mol) in water (50 ml) was added drop-wise to the above reaction mixture at 0-5° C., the reaction mixture was stirred for 2 hours at 5-20° C. and then at room temperature for 16 hours. The resultant precipitate was collected by filtration, washed with water (1000 ml) and then with a mixture of methanol (1600 ml) and water (400 ml). The solid was dried in a desiccator to give 150 g of an orange solid.

### Stage (d) Preparation of Intermediate (1d)

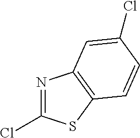

5-Chloro-2-mercaptobenzothiazole (75 g, 0.37 mol) was added in portions over 1 hour to sulfuryl chloride (500 g, 3.7 mol) stirred at 20-25° C. On completion of the addition the reaction mixture was stirred at 60° C. for 1 hour and then added slowly to ice (3000 g). The resultant solid was collected by filtration, washed with water (1000 ml) and dried. The crude product was stirred in methanol (1000 ml) for 1 hour, screened from insoluble material and the filtrates evaporated under reduced pressure. The residue was recrystallised from a mixture of ethanol (300 ml) and water (100 ml) to give 49 g of a white powder.

### Stage (e) Preparation of Intermediate (1e)

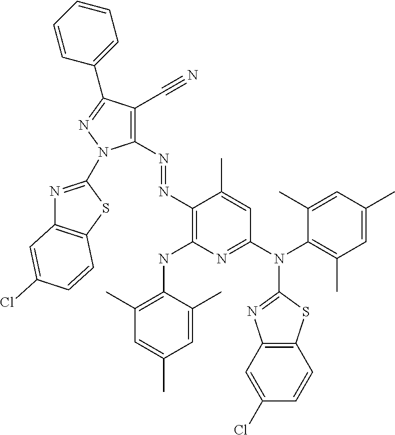

A mixture of intermediate (1c) (21 g, 0.037 mol), intermediate (1d) (28 g, 0.136 mol), tetrabutylammonium bromide (2.8 g, 0.0089 mol), potassium carbonate (29 g, 0.152 mol) and dimethylsulfoxide (71 ml, 1.0 mol) was stirred in an atmosphere of nitrogen at 95° C. for 10 hours. The crude product was collected by filtration and washed with dimethylsulfoxide (2×25 ml). The solid was stirred in water (1000 ml) for 1 hour, collected by filtration and washed first with water (500 ml) and then with methanol (500 ml) and pulled dry. The crude product was recrystallised from a mixture of toluene (150 ml) and methanol (150 ml) to give 13 g of a red powder.

### Stage (f)

### Preparation of the Title Dye

Intermediate (1e) (3.0 g, 0.0037 mol) was added in portions to 20% oleum (30 ml) at 15-20° C. The reaction mixture was stirred at 20° C. for 3 hours and then drowned into a mixture of ice and water (300 g), the resultant precipitate was collected by filtration and then redissolved in water (300 ml). The solution was neutralised with NaOH, dialysed to low conductivity and dried at 60° C. to give 4.4 g of a dark red solid.

Examples 2-12, shown below, were prepared in a similar manner.

| | | Average number of |
|---|---|---|
| Example | structure | sulfonic acid residues |
| Compound(2) | 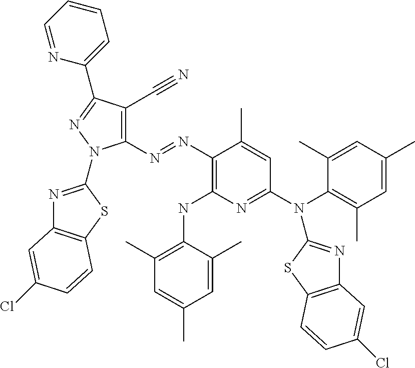 | 3 |
| Compound(3) | 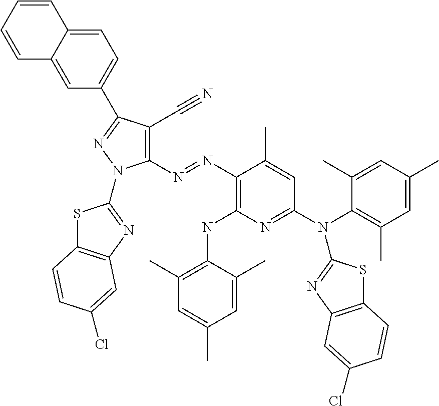 | 5 |
| Compound(4) | 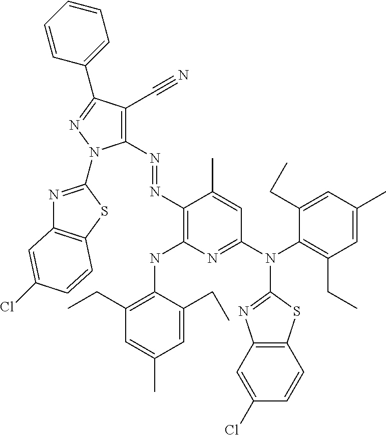 | 4 |
| Compound(5) | 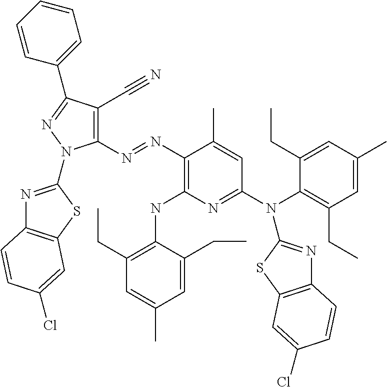 | 4 |
| Compound(6) | 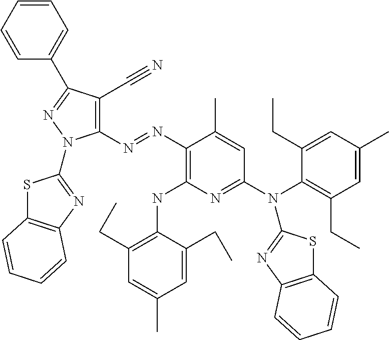 | 5 |
| Compound(7) | 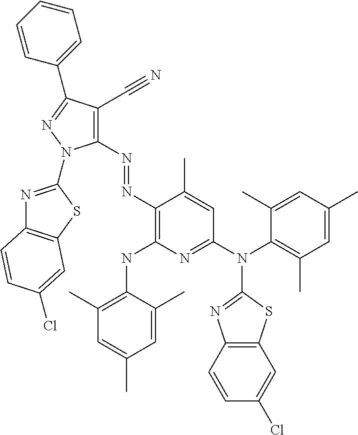 | 4 |
| Compound(8) | 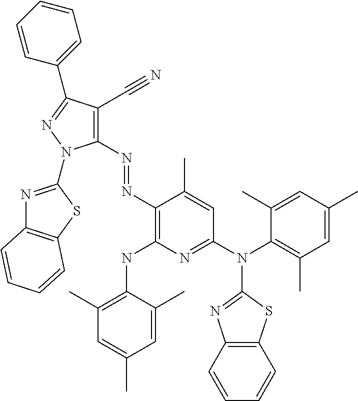 | 5 |
| Compound(9) | 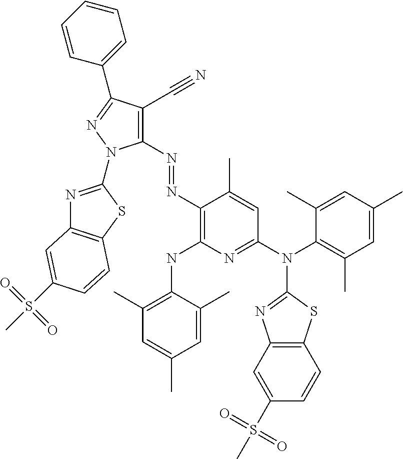 | 4 |
| Compound(10) | 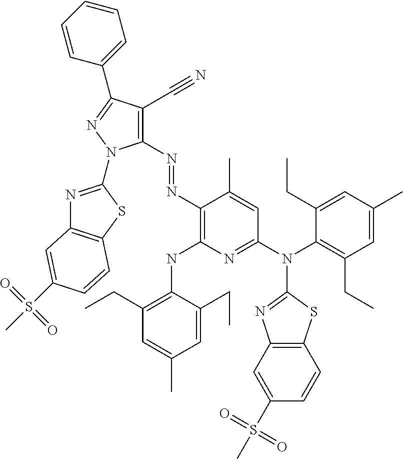 | 4 |
| Compound(11) | 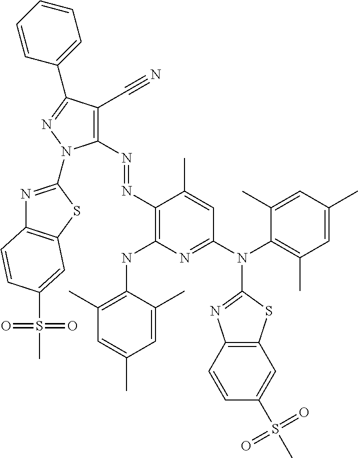 | 4 |
| Compound(12) | 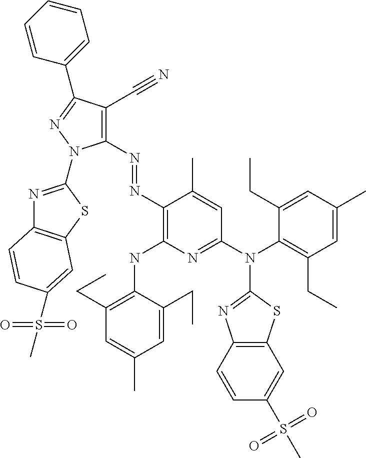 | 4 |

### COMPARATIVE EXAMPLE

Example dye F1 from U.S. Pat. No. 7,108,743 was used as a comparative example:

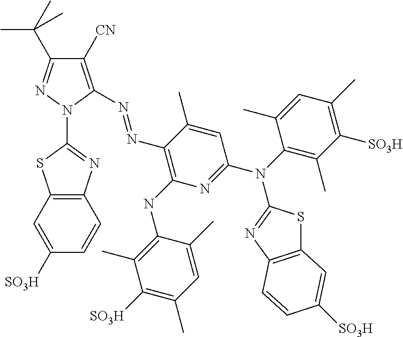

### EXAMPLE 13

### Preparation of Inks

Example Ink and a Comparative Ink were prepared by dissolving 3.2 g of the compound of Example 1 or the Comparative Example dye in a liquid medium comprising (% by weight):

| | |
|---|---|
| Diethyleneglycol | 7% |
| 2-Pyrollidone | 7% |
| Ethyleneglycol | 7% |
| Surfynol ™ 465 | 1% |
| Tris buffer | 0.2% |
| Water | 77.8% |

Surfynol^{R} ™ 465 is a surfactant from Air Products.

### EXAMPLE 14

### Ink-Jet Printing

Ink prepared as described above was filtered through a 0.45 micron nylon filter and then incorporated into empty print cartridges using a syringe.

This was then printed on to Canon Premium PR101Photo Paper (PR101) at 50% depth.

The resultant prints were tested for ozone fastness by exposure to 5 ppm ozone at 25° C., 50% relative humidity for 24 hrs in a Hampden 903 Ozone cabinet. Fastness of the printed ink to ozone was judged by the difference in the optical density before and after exposure to ozone.

Optical density measurements were performed using a Gretag spectrolino spectrophotometer set to the following parameters:

Measuring Geometry: 0°/45°

Spectral Range: 380-730 nm

Spectral Interval: 10 nm

Illuminant: D50

Observer: 2° (CIE 1931)

Density: Ansi A

External Filler: None

Ozone fastness was assessed by the percentage change in the optical density of the print, where a lower figure indicates higher fastness. Even the change of a few percent can correlate to a significant improvement in performance. The results are shown below

| Ink | % OD Loss PR101 |
|---|---|
| Example Ink | 27.45 |
| Comparative Ink | 29.7 |

Thus, the dyes of the present invention display an unexpected and significantly improved ozone fastness on a number of ink-jet media when compared to a close structural analogue.

### Further Inks

The inks described in Tables A and B may be prepared using the disazo compound of Example 1 as a dye. The dye indicated in the first column is dissolved in 100 parts of the ink as specified in the second column on. Numbers quoted in the second column onwards refer to the number of parts of the relevant ink ingredient and all parts are by weight. The pH of the ink may be adjusted using a suitable acid or base. The inks may be applied to a substrate by ink-jet printing.

The following abbreviations are used in Tables A and B:

PG=propylene glycol

DEG=diethylene glycol

NMP=N-methylpyrrolidone

DMK=dimethylketone

IPA=isopropanol

2P=2-pyrrolidone

MIBK=methylisobutyl ketone

P12=propane-1,2-diol

BDL=butane-2,3-diol

TBT=tertiary butanol

TABLE A

| Dye | Water | PG | DEG | NMP | DMK | IPA | 2P | MIBK |
|---|---|---|---|---|---|---|---|---|
| 2.0 | 80 | 5 | | 6 | 4 | | 5 | |
| 3.0 | 90 | | 5 | 5 | | | | |
| 10.0 | 85 | 3 | | 3 | 3 | | 6 | |
| 2.1 | 91 | | 8 | | | | | 1 |
| 3.1 | 86 | 5 | | | | 4 | | 5 |
| 1.1 | 81 | | | 9 | | | 10 | |
| 2.5 | 60 | 4 | 15 | 3 | 3 | 6 | 5 | 4 |
| 5 | 65 | | 20 | | | 10 | 5 | |
| 2.4 | 75 | 5 | 10 | | 5 | | | 5 |
| 4.1 | 80 | 3 | 5 | 2 | 10 | | | |
| 3.2 | 65 | | 5 | 4 | 6 | 5 | 10 | 5 |
| 5.1 | 96 | | | | | | 4 | |
| 10.8 | 90 | 5 | | | | 5 | | |
| 10.0 | 80 | 2 | 6 | 2 | 5 | 1 | 4 | |
| 1.8 | 80 | | 5 | | | | 15 | |
| 2.6 | 84 | | | 11 | | | 5 | |
| 3.3 | 80 | 4 | | | 10 | | | 6 |
| 12.0 | 90 | | | | 7 | 3 | | |
| 5.4 | 69 | 2 | 20 | 2 | 1 | | 3 | 3 |
| 6.0 | 91 | | | 4 | | | 5 | |

TABLE B

| Dye | | | | | | | |
|---|---|---|---|---|---|---|---|
| Content | Water | PG | DEG | NMP | TBT | BDL | PI2 |
| 3.0 | 80 | 20 | | | | | |
| 9.0 | 90 | | 5 | | | | 5 |
| 1.5 | 85 | 5 | 5 | | 5 | | |
| 2.5 | 90 | | 6 | 4 | | | |
| 3.1 | 82 | 4 | 8 | | | | 6 |
| 0.9 | 85 | | 10 | | | 5 | |
| 8.0 | 90 | | 5 | 5 | | | |
| 4.0 | 70 | | 10 | 4 | | 5 | 11 |
| 2.2 | 75 | 10 | 10 | 3 | | 2 | |
| 10.0 | 91 | | | 9 | | | |
| 9.0 | 76 | | 9 | 7 | 3 | 5 | |
| 5.0 | 78 | 5 | 11 | | | 6 | |
| 5.4 | 86 | | | 7 | 7 | | |
| 2.1 | 70 | 5 | 10 | 5 | 5 | 5 | |
| 2.0 | 90 | | 10 | | | | |
| 2 | 88 | | 12 | | | | |
| 5 | 78 | | | 5 | | 7 | 10 |
| 8 | 70 | 2 | 20 | 8 | | | |
| 10 | 80 | 10 | 10 | | | | |
| 10 | 80 | | 20 | | | | |

1. A compound of Formula (1) and salts thereof: 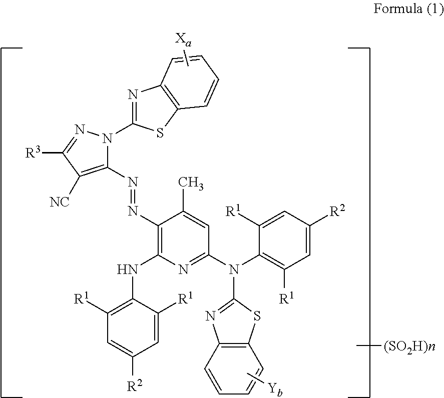
wherein:
R¹ and R² are independently H or optionally substituted C₁₋₄ alkyl;
R³ is optionally substituted aryl or optionally substituted heteroaryl;
X and Y are independently an acetyl group, an acetate ester group, a carbonamide group, a sulfoxide group, a sulfone group, a phosphonate group, a nitro group, a nitrile group, an isonitrile group, a quaternary amine, a carbonyl group (other than a carboxylic acid), a polyhaloalkyl group or a halogen atom;
a+b=0 to 4; and
n=1 to 6.

2. A compound of Formula (1) and salts thereof as claimed in claim 1 wherein R¹ and R² are independently H or unsubstituted C₁₋₄ alkyl.

3. A compound of Formula (1) and salts thereof as claimed in claim 1 wherein R¹ is methyl or ethyl.

4. A compound of Formula (1) and salts thereof as claimed in claim 1 wherein R² is methyl.

5. A compound of Formula (1) and salts thereof as claimed in claim 1 wherein R³ is optionally substituted phenyl or optionally substituted naphthyl.

6. A compound of Formula (1) and salts thereof as claimed in claim 1 wherein X and Y are independently selected from the group consisting of —Cl, —CN, —NO₂, —CF₃, —SO₂R⁴ wherein R⁴ is optionally substituted alkyl, optionally substituted aryl or optionally substituted heterocyclyl.

7. A compound of Formula (1) and salts thereof as claimed in claim 1 wherein X and Y are independently —Cl and —SO₂R⁴.

8. A compound of Formula (1) and salts thereof as claimed in claim 1 wherein X and Y are the same.

9. A compound of Formula (1) and salts thereof as claimed in claim 1 wherein (a+b) is 1 to 4.

10. A compound of Formula (1) and salts thereof as claimed in claim 1 wherein n is 3 to 6.

11. A composition comprising a compound of Formula (1) and/or a salt thereof, as described in claim 1, and a liquid medium.

12. A composition as claimed in claims 11 which is ink suitable for use in an ink jet printer.

13. A process for forming an image on a substrate comprising applying ink suitable for use in an ink-jet printer, according to claim 12, thereto by means of an ink-jet printer.

14. A material printed with a compound of Formula (1) as described claim 1.

15. An ink-jet printer cartridge comprising a chamber and ink suitable for use in an ink-jet printer, according to claim 12, wherein the ink is in the chamber.
